(19) United States
(12) Patent Application Publication
(10) Pub. No.: US 2025/0304813 A1
(43) Pub. Date: Oct. 2, 2025

(54) Treatment Liquid Composition For Ink Jet And Ink Set

(71) Applicant: SEIKO EPSON CORPORATION, Tokyo (JP)

(72) Inventors: Ryota MIYASA, Matsumoto (JP); Akiko YAMADA, Shiojiri (JP)

(21) Appl. No.: 19/092,213

(22) Filed: Mar. 27, 2025

(30) Foreign Application Priority Data
Mar. 28, 2024 (JP) 2024-054081

(51) Int. Cl. C09D 11/54; C09D 11/102; C09D 11/326; C09D 11/40

(52) U.S. Cl. CPC C09D 11/54; C09D 11/102; C09D 11/326; C09D 11/40

(57) ABSTRACT

There is provided a treatment liquid composition for ink jet, which is used by being adhered to a recording medium, the treatment liquid composition for ink jet, containing an acid compound, a base compound, water, in which in the acid compound, a pka at 25° C. in water is at least 2.5 or more and 7.0 or less, and in the treatment liquid composition for ink jet, a difference (C_{A}−C_{B}) between a mass molar concentration C_{A} (mol/kg) of an acidic group derived from the acid compound and a mass molar concentration C_{B} (mol/kg) of a basic group derived from the base compound is 0.01 or more, and a pH at 25° C. is 2.5 or more and 6.5 or less.

The present application is based on, and claims priority from JP Application Serial Number 2024-054081, filed Mar. 28, 2024, the disclosure of which is hereby incorporated by reference herein in its entirety.

### BACKGROUND

### 1. Technical Field

The present disclosure relates to a treatment liquid composition for ink jet and an ink set.

### 2. Related Art

Ink jet recording methods can record high-definition images with a relatively simple apparatus and are rapidly developed in various fields. In such process, various studies are made on color developing properties, washing fastness, and the like. For example, WO 2023/042761 discloses a treatment liquid for ink jet, which contains a water-soluble cationic polymer and an organic acid salt, in which a content of the water-soluble cationic polymer is 0.1% by weight or more and less than 10% by weight with respect to the entire treatment liquid.

By the way, in a case where a treatment liquid composition obtained by such a configuration in the related art as in WO 2023/042761 is used, there is room for improvement in friction fastness of a textile printed matter to be obtained. There is a demand for a treatment liquid composition for ink jet, which is excellent in stimulus mitigating properties while maintaining favorable friction fastness.

### SUMMARY

The treatment liquid composition for ink jet according to the present disclosure is a treatment liquid composition for ink jet, which is used by being adhered to a recording medium, where the treatment liquid composition for ink jet contains an acid compound, a base compound; and water, in which in the acid compound, a pKa at 25° C. in water is at least 2.5 or more and 7.0 or less, and in the treatment liquid composition for ink jet, a difference (C_{A}−C_{B}) between a mass molar concentration C_{A} (mol/kg) of an acidic group derived from the acid compound and a mass molar concentration C_{B} (mol/kg) of a basic group derived from the base compound is 0.01 or more, and a pH at 25° C. is 2.5 or more and 6.5 or less.

An ink set according to the present disclosure includes the treatment liquid composition for ink jet described above, and an aqueous pigment ink composition containing an anionic dispersing pigment and an anionic resin particle.

### BRIEF DESCRIPTION OF THE DRAWINGS

FIG. 1 is Table 1 that shows compositions of treatment liquids used in Examples and evaluation results thereof.

FIG. 2 is Table 2 that shows compositions of treatment liquids used in Examples and evaluation results thereof.

FIG. 3 is Table 3 that shows compositions of treatment liquids used in Examples and evaluation results thereof.

FIG. 4 is Table 4 that shows compositions of treatment liquids used in Examples and evaluation results thereof.

FIG. 5 is Table 5 that shows compositions of treatment liquids used in Examples and evaluation results thereof.

FIG. 6 is Table 6 that shows compositions of aqueous pigment inks and coating liquids used in Examples.

### DESCRIPTION OF EMBODIMENTS

Hereinafter, an embodiment of the present disclosure (hereinafter referred to as “the present embodiment”) is described in detail with reference to the drawings as necessary. However, the present disclosure is not limited thereto and can be variously modified without departing from the gist of the present disclosure.

### 1. Treatment Liquid Composition for Ink Jet

The treatment liquid composition for ink jet according to the present disclosure (hereinafter, also referred to as a treatment liquid composition) is a treatment liquid composition for ink jet, which is used by being adhered to a recording medium, where the treatment liquid composition for ink jet contains an acid compound, a base compound; and water, in which in the acid compound, a pka at 25° C. in water is at least 2.5 or more and 7.0 or less, and in the treatment liquid composition for ink jet, a difference (C_{A}−C_{B}) between a mass molar concentration C_{A} (mol/kg) of an acidic group derived from the acid compound and a mass molar concentration C_{B} (mol/kg) of a basic group derived from the base compound is 0.01 or more, and a pH at 25° C. is 2.5 or more and 6.5 or less.

In the related art, the treatment liquid uses an organic acid or a polyvalent metal salt as an aggregating agent for aggregating the ink. However, the polyvalent metal salt has strong aggregating power, and the wet friction fastness of a recorded matter to be obtained tends to decrease although a recorded matter in which color developing properties or bleed-through is suppressed is obtained. On the other hand, the organic acid undergoes a neutralization reaction with an anionic component of the ink thereby reducing the hydrophilicity of the anionic component. Therefore, it is possible to obtain a recorded matter having excellent wet friction fastness.

A textile printed matter is often used for the intended purpose of being used in a product that directly touches the skin of a human or an animal. However, in a case of a textile printed matter that is subjected to a pretreatment using an organic acid, there is a concern of increased skin stimulativeness. Therefore, it is needed to alleviate skin stimulation while maintaining friction fastness.

In this respect, in the present disclosure, in a case where an acid compound in which a pka at 25° C. in water is at least 2.5 or more and 7.0 or less, and a base compound were contained, and further a difference (C_{A}−C_{B}) between a mass molar concentration C_{A} (mol/kg) of an acidic group derived from the acid compound and a mass molar concentration C_{B} (mol/kg) of a basic group derived from the base compound was to 0.01 or more, and a pH of a treatment liquid at 25° C. was set to 2.5 or more and 6.5 or less, it was possible to obtain a recorded matter having excellent stimulus mitigating properties and excellent friction fastness.

As described above, in a case where an acid compound having a pKa of 2.5 or more and 7.0 or less is used, it is possible to improve the wet friction fastness, and on the other hand, it is possible to reduce the stimulativeness caused by the acid compound by using a base compound. In addition, regarding the point that the reactivity of the acid compound is lowered by using a base compound, by using an acid compound having a pka of 2.5 or more in a range of pH 2.5 to 6.5 and setting the difference in mass molar concentration (C_{A}−C_{B}) to 0.01 or more, it is possible to reduce the proportion of the formation of a neutralization salt by reacting with a base in the treatment liquid. Therefore, it is considered that the friction fastness is excellent because the action of the acid compound is maintained while suppressing the stimulativeness due to the acid compound, and then the neutralization reaction sufficiently proceeds between the acid compound and the ink, which reduces the hydrophilicity of the component in the ink.

In the present specification, the term “acid” and “acid compound” refer to those having a pH of less than 7 in a case of being made into a 0.1% by mass aqueous solution at 25° C. Further, a compound having at least a pka of 2.5 or more and 7.0 or less corresponds to the acid compound. In addition, the term “base” and “base compound” refer to those having a pH of more than 7 in a case of being made into a 0.1% by mass aqueous solution at 25° C. Further, it is preferable that the pka of the conjugate acid of the base is 12 or less.

Hereinafter, each component contained in the treatment liquid composition will be described in detail.

### 1.1. Acid Compound

Examples of the acid compound include an organic acid and an inorganic acid. An organic acid is preferable from the viewpoint of making the textile printed matter more excellent in stimulus mitigating properties and friction fastness. One kind of acid compound may be used alone, or two or more kinds thereof may be used in combination. It is noted that the acid compound and the base compound may form a neutralization salt in the treatment liquid composition.

In the present specification, the fact that a compound has a pKa within a certain range refers to that in a case where a compound has a single pKa, the pKa thereof is within a predetermined range and that in a case where a compound has a plurality of values of pKa, one or more values of pKa are within a predetermined range.

The pKa of the acid compound in water at 25° C. is not particularly limited as long as it is at least 2.5 or more and 7.0 or less; however, it is preferably in a range of 3.0 or more and 6.8 or less, in a range of 4.0 or more and 6.7 or less, or in a range of 4.5 or more and 6.5 or less. In a case where the pKa of the acid compound in water at 25° C. is in the above-described range, the buffering ability can be exhibited in a range of pH 2.5 to 6.5, and the degree of neutralization with the base compound can be further reduced. Therefore, a lot of non-neutralized acid compounds remain in the treatment liquid composition while the stimulativeness is suppressed. As a result, the friction fastness tends to be further excellent.

The standard boiling point or the thermal decomposition point of the acid compound at atmospheric pressure is preferably 350° C. or lower, 300° C. or lower, 250° C. or lower, 200° C. or lower, 170° C. or lower, or 150° C. or lower. The lower limit of the standard boiling point or the thermal decomposition point of the acid compound at atmospheric pressure may be 100° C. or higher. In a case where the standard boiling point or the thermal decomposition point of the acid compound at atmospheric pressure is set within the above-described range, the acid compound derived from the treatment liquid composition tends to be easily volatilized or decomposed during the drying of the recorded matter. In a case where the acid compound is volatilized or decomposed in this manner, the acid compound is removed from the recorded matter, and thus a recorded matter to be obtained tends to be further excellent in stimulus mitigating properties and friction fastness.

Suitable examples of the acid compound as an organic acid include lactic acid, malonic acid, citric acid, adipic acid, succinic acid, malic acid, levulinic acid, phosphoric acid, glutaric acid, polyacrylic acid, acetic acid, glycolic acid, maleic acid, ascorbic acid, fumaric acid, tartaric acid, sulfonic acid, orthophosphoric acid, pyrrolidone carboxylic acid, pyrone carboxylic acid, pyrrole carboxylic acid, furan carboxylic acid, pyridine carboxylic acid, coumarin acid, thiophene carboxylic acid, nicotinic acid, or derivatives of these compounds, or salts thereof. Among these, one or more selected from the group consisting of lactic acid, levulinic acid, malic acid, malonic acid, citric acid, phosphoric acid, succinic acid, glutaric acid, and adipic acid are preferable. In addition, one or more selected from the group consisting of lactic acid, malonic acid, citric acid, adipic acid, succinic acid, malic acid, levulinic acid, glutaric acid, and phosphoric acid are more preferable. In a case where such an acid compound is contained, a textile printed matter to be obtained tends to have further excellent stimulus mitigating properties and friction fastness.

The content of the acid compound is preferably 1.0% to 50% by mass, 2.0% to 40% by mass, 3.5% to 30% by mass, or 4.0% to 15% by mass with respect to the total amount of the treatment liquid composition. In a case where the content of the acid compound is set within the above-described range, the textile printed matter tends to have further excellent stimulus mitigating properties and friction fastness.

### 1.2. Base Compound

Examples of the base compound include an organic base and an inorganic base. Among the organic base and the inorganic base, a metal hydroxide or an amine compound is preferable. In a case where a metal hydride or an amine compound is used, the textile printed matter tends to have further excellent stimulus mitigating properties and friction fastness.

One kind of base compound may be used alone, or two or more kinds thereof may be used in combination. From the viewpoint of further improving the stimulus mitigating properties and the friction fastness of the textile printed matter, it is preferable to use two or more base compounds. A base compound having low water solubility contributes to the improvement of wet friction fastness, whereas the amount thereof added to the treatment liquid composition is easily limited due to the low water solubility, and the adjustment of pH also tends to be difficult. In this respect, in a case where another kind of base is used in combination, the flexibility of the pH adjustment is further improved, and the pH of the extraction liquid tends to be capable of being more suitable.

The metal constituting the metal hydroxide is preferably one or more selected from the group consisting of Li, Na, K, Ca, Mg, and Al, and it is more preferably one or more selected from the group consisting of Na, K, Ca, Mg, and Al. In a case where such a hydroxide of a metal and an amine compound are used, the textile printed matter tends to have further excellent stimulus mitigating properties and friction fastness. In addition, Li, Na, K, or a monoamine has high solubility in water and is unlikely to form precipitates in the reaction solution, and thus has excellent storage stability. Regarding Ca, Mg, Al, or a polyamine, wet friction fastness, particularly, the wet friction fastness in the polyester fabric tends to be further improved.

From the same viewpoint, it is preferable that the base compound includes a hydroxide of one or more metals selected from the group consisting of Ca, Mg, and Al, or an amine compound having 2 to 10 nitrogen atoms in a molecule, or includes a hydroxide of one or more metals selected from the group consisting of Ca, Mg, and Al, or an amine compound having 2 to 6 nitrogen atoms in a molecule. In particular, in a case where such a base compound is used, wet friction fastness, particularly, the wet friction fastness in the polyester fabric tends to be further improved. In addition, in the printed material, by binding (neutralizing) to an anionic group of the anionic dispersing pigment or the anionic resin particles in the ink composition described later, it is possible to form a neutralization salt having relatively low solubility in water, and it is possible to increase the molecular weight due to being a polyvalent base. Therefore, the elution from the ink coating film of the printed material during wet friction is less likely to occur, and thus the wet friction fastness is favorable.

The metal hydroxide is preferably one or more selected from the group consisting of LiOH, NaOH, KOH, Ca(OH)₂, Mg(OH)₂, and Al(OH)₃, or it is preferably one or more selected from the group consisting of NaOH, KOH, Ca(OH)₂, Mg(OH)₂, and Al(OH)₃. In a case where such a metal hydroxide is used, the textile printed matter tends to have further excellent stimulus mitigating properties and friction fastness.

The amine compound is preferably one or more selected from the group consisting of an alkanol amine compound, a polyvalent amine compound, and a polyamine compound. In a case where such an amine compound is used, the textile printed matter tends to have further excellent stimulus mitigating properties and friction fastness.

Examples of the alkanol amine compound include triethanol amine, tripropanol amine, triisopropanol amine, and tributanol amine. Among these, triisopropanol amine is preferable from the viewpoint of further improving the stimulus mitigating properties and the friction fastness of the textile printed matter. Examples of the polyvalent amine compound include diethylenetriamine, dipropylenetriamine, dihexylenetriamine, triethylenetetramine, tetraethylenepentamine, pentaethylenehexamine, and hexaethyleneheptamine. Among these, dipropylenetriamine is preferable from the same viewpoint as described above.

The polyamine compound may be any compound having an amino group in the structure, and examples thereof include a polyamine resin, a polyamide resin, and a polyallylamine resin. As the polyamine compound, a commercially available product which corresponds to the basic compound in the present specification may be used. Examples of the polyamine compound as a commercially available product include PAA-SA, PAA-01, 03, 05, 08, 15, 15C, 25, PAA-H-10C, PAA-D11-HCL, PAA-D41-HCL, PAA-D19-HCL, PAS-21CL, 22SA, 92, 92A, PAS-M-1, 1L, 1A, PAS-H-1L, 5L, 10L, and PAS-J-81, 81L (hereinabove, all product names, manufactured by Nittobo Medical Co., Ltd.), FL-14 (manufactured by SNF), ARAFIX 100, 251S, 255, 255LOX (manufactured by Arakawa Chemical Industries, Ltd.), DK-6810, 6853, 6885; WS-4010, 4011, 4020, 4024, 4027, 4030 (manufactured by SEIKO PMC Corporation), PAPYOGEN P-105 (manufactured by SENKA Corporation), Sumirez Resin 650 (30), 675A, 6615, SLX-1 (manufactured by Taoka Chemical Co., Ltd.), Catiomaster (registered trademark) PD-1, 7, 30, A, PDT-2, PE-10, PE-30, DT-EH, EPA-SK01, TMHMDA-E (manufactured by Yokkaichi Chemical Co., Ltd.), and JETFIX 36N, 38A, N700, 5052 (manufactured by Satoda Chemical Industrial Co., Ltd.). Among these, PAA-03 is preferable from the viewpoint of further improving the stimulus mitigating properties and the friction fastness of the textile printed matter.

Examples of the polyallylamine resin include a polyallylamine hydrochloride, a polyallylamineamide sulfate, an allylamine hydrochloride/diallylamine hydrochloride copolymer, an allylamine acetate/diallylamine acetate copolymer, an allylamine acetate/diallylamine acetate copolymer, an allylamine hydrochloride/dimethylallylamine hydrochloride copolymer, an allylamine/dimethylallylamine copolymer, a polydiallylamine hydrochloride, a polymethyldiallylamine hydrochloride, a polymethyldiallylamineamide sulfate, a polymethyldiallylamine acetate, a polydiallyldimethylammonium chloride, a diallylamine acetate/sulfur dioxide copolymer, a diallylmethylethylammonium ethylsulfate/sulfur dioxide copolymer, a methyldiallylamine hydrochloride/sulfur dioxide copolymer, a diallyldimethylammonium chloride/sulfur dioxide copolymer, and a diallyldimethylammonium chloride/acrylamide copolymer.

The content of the base compound is preferably 0.1% to 30% by mass, 0.2% to 20% by mass, 0.25% to 15% by mass, or 0.4% to 13% by mass with respect to the total amount of the treatment liquid composition. In a case where the content of the base compound is set within the above-described range, the textile printed matter tends to have further excellent stimulus mitigating properties and friction fastness.

### 1.3. Acidic Group and Basic Group

In the treatment liquid composition, a difference (C_{A}−C_{B}) between a mass molar concentration C_{A} (mol/kg) of an acidic group derived from the acid compound and a mass molar concentration C_{B} (mol/kg) of a basic group derived from the base compound is 0.01 or more. In a case where the difference in mass molar concentration (C_{A}−C_{B}) in the treatment liquid is set to 0.01 or more, a textile printed matter to be obtained has excellent friction fastness and stimulus mitigating properties. From the same viewpoint, the difference in mass molar concentration (C_{A}−C_{B}) in the treatment liquid is preferably 0.01 or more and 5.0 or less, 0.1 or more and 4.8 or less, 0.2 or more and 4.5 or less, 0.5 or more and 4.0 or less, 0.5 or more and 2.0 or less, or 0.5 or more and 1.2 or less. It is noted that one kind of each of the acidic group and the basic group may be contained alone, or two or more kinds thereof may be contained.

The acidic group is not particularly limited as long as it is contained in the acid compound described above, and examples thereof include a carboxyl group, a sulfo group, a phosphoric acid group, a phenol group, and a sulfite group. Among these, one or more selected from the group consisting of a carboxyl group, a sulfo group, and a phosphoric acid group are preferable, and a carboxyl group is more preferable from the viewpoint of further improving the stimulus mitigating properties and the friction fastness of the textile printed matter.

The basic group is not particularly limited as long as it is contained in the base compound described above, and examples thereof include a hydroxyl group, an amino group, and an imidazole group. Among these, a hydroxyl group or an amino group is preferable, and an amino group is more preferable from the viewpoint described above.

The mass molar concentration C_{A} (mol/kg) of the acidic group is preferably 0.30 or more, 0.30 or more and 7.0 or less, 0.30 or more and 6.5 or less, or 0.50 or more and 5.0 or less. In a case where the mass molar concentration C_{A} (mol/kg) is set within the above-described range, the stimulus mitigating properties and the friction fastness tend to be more excellent. It is noted that the acid compound may also have a basic group. In this case, in the present embodiment, the mass molar concentration C_{A} (mol/kg) is calculated in consideration of the concentration of the acidic group of the acid compound, and the basic group of the acid compound is not considered in a case of calculating the concentration.

The mass molar concentration C_{B} (mol/kg) of the basic group is preferably 0.01 or more and 5.0 or less, 0.03 or more and 3.0 or less, or 0.05 or more and 2.5 or less. In a case where the mass molar concentration C_{B} (mol/kg) is set within the above-described range, the effects of the stimulus mitigating properties and the friction fastness according to the present disclosure can be further exhibited effectively and reliably. It is noted that the base compound may also have an acidic group. In this case, in the present embodiment, the mass molar concentration C_{B} (mol/kg) is calculated in consideration of the concentration of the basic group of the base compound, and the acidic group of the base compound is not considered in a case of calculating the concentration.

It is noted that the polyvalent metal salt is divided into an acid and a base (a hydroxide of a polyvalent metal) constituting the polyvalent metal salt, and the mass molar concentration C_{A} (mol/kg) of the acidic group and the mass molar concentration C_{B} (mol/kg) of the basic group are considered For example, in a case of only a completely neutralized compound such as calcium lactate, the difference in mass molar concentration (C_{A}−C_{B}) is 0 and thus does not become 0.01 or more. On the other hand, in a case of calcium monohydrogen citrate or disodium hydrogen citrate, two of the three acidic groups of citric acid are neutralized, one thereof is present as an acidic group, and thus the difference in mass molar concentration (C_{A}−C_{B}) is a positive value.

### 1.4. Water-Soluble Organic Solvent

The treatment liquid composition may contain a water-soluble organic solvent. The organic solvent is not particularly limited as long as it is water-soluble, and examples thereof include polyhydric alcohols, glycol ethers, nitrogen-containing solvents, ethers, and cyclic esters. Among these, polyhydric alcohols are preferable from the viewpoint of further improving the stimulus mitigating properties and the friction fastness of the textile printed matter. It is noted that one kind of organic solvent may be used alone, or two or more kinds thereof may be used in combination.

The polyhydric alcohols can be classified into, for example, polyols and diol compounds. Specific examples of the polyols include glycerin, ethylene glycol, propylene glycol, 1,2-propanediol, 1,2-butanediol, 1,3-propanediol, 1,4-butanediol, diethylene glycol, triethylene glycol, dipropylene glycol, and trimethylolpropane. Among these, it is preferable to include one or more selected from the group consisting of glycerin, propylene glycol, and triethylene glycol from the viewpoint of further improving the stimulus mitigating properties and the friction fastness of the textile printed matter.

In addition, examples of the diol compound include 1,2-pentanediol, 1,2-hexanediol, 1,2-octanediol, 1,6-hexanediol, 2-methyl-2,4-pentanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, and the like. Among these, 1,2-hexanediol is preferably used from the viewpoint of further improving the stimulus mitigating properties and the friction fastness of the textile printed matter.

Further, specific examples of the glycol ethers include triethylene glycol monobutyl ether, ethylene glycol monomethyl ether, ethylene glycol monoethyl ether, ethylene glycol monopropyl ether, ethylene glycol monobutyl ether, ethylene glycol monomethyl ether acetate, diethylene glycol monomethyl ether, diethylene glycol monoethyl ether, diethylene glycol monopropyl ether, diethylene glycol monobutyl ether, diethylene glycol mono-t-butyl ether, 1-methyl-1-methoxybutanol, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, propylene glycol monobutyl ether, dipropylene glycol monobutyl ether, 3-methoxy-3-methyl-1-butanol, ethylene glycol dimethyl ether, ethylene glycol diethyl ether, ethylene glycol dibutyl ether, diethylene glycol dimethyl ether, and diethylene glycol diethyl ether. Among these, triethylene glycol monobutyl ether is preferably used from the viewpoint of further improving the stimulus mitigating properties and the friction fastness of the textile printed matter.

The content of the organic solvent is preferably 5% to 50% by mass, 10% to 40% by mass, or 12% to 30% by mass with respect to the total amount of the treatment liquid composition. In a case where the content of the organic solvent is set within the above-described range, the stimulus mitigating properties and the friction fastness tend to be more excellent. From the same viewpoint, the content of the polyhydric alcohols or polyols is preferably 5% to 50% by mass, 10% to 40% by mass, or 12% to 30% by mass with respect to the total amount of the treatment liquid composition.

It is preferable that the treatment liquid composition contains 5.0% by mass or more of a water-soluble organic solvent having a standard boiling point of 280° C. or higher with respect to the total amount of the treatment liquid composition. In a case where the content of the organic solvent having a standard boiling point of 280° C. or higher is set to the above-described content, the stimulus mitigating properties and the friction fastness tend to be more excellent. In addition, the ejection stability tends to be further improved in a case where the treatment liquid composition is ejected by an ink jet method. From the same viewpoint, it is more preferable that the water-soluble organic solvent having a standard boiling point of 280° C. or higher is contained such that the content thereof is 5.0% to 30% by mass or 7.0% to 25% by mass with respect to the total amount of the treatment liquid composition.

### 1.5. Surfactant

The treatment liquid composition may contain a surfactant. Examples of the surfactant include a nonionic surfactant, an anionic surfactant, and an amphoteric surfactant. A nonionic surfactant is preferable from the viewpoint of further improving the ejection stability in a case where the treatment liquid composition is ejected by the ink jet method. The nonionic surfactant is also preferable in that the nonionic surfactant tends to be stable even in the treatment liquid composition containing an acid compound and a base compound. It is noted that one kind of surfactant may be used alone, or two or more kinds thereof may be used in combination.

It is preferable that the treatment liquid composition contains a nonionic surfactant and a water-soluble organic solvent, and further, the water-soluble organic solvent includes one or more of a diol compound having 4 or more carbon atoms and glycol ethers having 4 or more carbon atoms. In a case where the concentration of the neutralization salt generated by the acid compound and the base compound in the treatment liquid composition is high, the water solubility of the nonionic surfactant tends to decrease. In this respect, the solubility of the nonionic surfactant can be improved in a case where the above-described diol compound and the above-described glycol ethers are contained in combination. In a case where the treatment liquid contains such a compound, the effects of the stimulus mitigating properties and the friction fastness according to the present disclosure can be further exhibited effectively and reliably.

Examples of the nonionic surfactant include an acetylene glycol-based surfactant, an alcohol ethoxylate-based surfactant, a fluorine-based surfactant, and a silicone-based surfactant. The acetylene glycol-based surfactant is not particularly limited; however, examples thereof include one or more selected from an alkylene oxide adduct of 2,4,7,9-tetramethyl-5-decyne-4,7-diol and 2,4,7,9-tetramethyl-5-decyne-4,7-diol, and an alkylene oxide adduct of 2,4-dimethyl-5-decyne-4-ol and 2,4-dimethyl-5-decyne-4-ol.

Examples of the acetylene glycol-based surfactant as a commercially available product include E series (product name, manufactured by Air Products and Chemicals, Inc.) such as OLFINE 104 series or OLFINE E1010, and SURFYNOL 61, 104, and 465 (product name, manufactured by Nissin Chemical Co., Ltd.). Among these, SURFYNOL 465 is preferable from the viewpoint that the effects of the stimulus mitigating properties and the friction fastness according to the present disclosure are further exhibited effectively and reliably.

The alcohol ethoxylate-based surfactant is a compound in which a polyoxyethylene chain and an alkyl group are bonded to each other by an ether bond, and it can be represented by a molecular formula of “R_{A}—O—(CH₂CH₂O)_{d}—H” and may be also referred to as a poly(oxyethylene) alkyl ether.

In the alcohol ethoxylate-based surfactant, the number of carbon atoms in an alkyl group (R_{A}) and the average molar number (d) of addition of an ethylene oxide chain are not limited; however, for example, the alkyl group (R_{A}) preferably has about 11 to 15 carbon atoms, and more preferably has about 12 to 13 carbon atoms; and the average molar number (d) of addition of the ethylene oxide chain is preferably about 3 to 15, and the average molar number of addition of the ethylene oxide group is more preferably about 5 to 10.

Examples of the alcohol ethoxylate-based surfactant include CL-40, CL-50, CL-70, CL-85, CL-95, CL-100, CL-120, CL-140, CL-160, CL-200, and CL-400 (product name, manufactured by Sanyo Chemical Industries, Ltd.), and the like.

Examples of the silicone-based surfactant include a polysiloxane-based compound, polyether-modified organosiloxane. Examples of the silicone-based surfactant as a commercially available product include BYK-306, BYK-307, BYK-333, BYK-341, BYK-345, BYK-346, BYK-347, BYK-348, and BYK-349 (hereinabove, all product names, manufactured by BYK JAPAN KK), and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (hereinabove, all product names, manufactured by Shin-Etsu Chemical Co., Ltd.). Among these, BYK-348 is preferable from the viewpoint that the effects of the stimulus mitigating properties and the friction fastness according to the present disclosure are further exhibited effectively and reliably.

Examples of the fluorine-based surfactant include, but are not particularly limited to, a perfluoroalkyl sulfonate, a perfluoroalkyl carboxylate, a perfluoroalkyl phosphate, a perfluoroalkyl ethylene oxide adduct, a perfluoroalkyl betaine, and a perfluoroalkylamine oxide compound.

Examples of the fluorine-based surfactant as a commercially available product include, but are not particularly limited to, S-144 and S-145 (manufactured by AGC Inc.); FC-170C, FC-430, and Fluorad FC4430 (manufactured by Sumitomo 3M Limited); FSO, FSO-100, FSN, FSN-100, and FS-300 (manufactured by Du Pont); FT-250 and 251 (manufactured by NEOS COMPANY LIMITED); and the like.

The content of the surfactant is preferably 0.01% to 3.0% by mass, 0.03% to 2.0% by mass, or 0.05% to 1.0% by mass with respect to the total amount of the treatment liquid composition. In a case where the content of the surfactant is set within the above-described range, the effects of the stimulus mitigating properties and the friction fastness according to the present disclosure can be further exhibited effectively and reliably.

### 1.6. Water

The treatment liquid contains water. As the water, it is preferable to use water from which ionic impurities are removed as much as possible, and examples of such water include pure water such as ion exchange water, ultrafiltration water, reverse osmosis water, or distilled water, and ultrapure water.

The content of water is preferably 30% to 90% by mass more preferably 40% to 80% by mass, and still more preferably 50% to 75% by mass with respect to the total amount of the treatment liquid composition. In a case where the content of the water in the treatment liquid is set within the above-described range, it is possible to more effectively and reliably exhibit the effect of the present disclosure.

### 1.7. Other Components

As components other than those described above, the treatment liquid may contain, for example, various additives such as a pH adjusting agent, a metal sealing agent, a softening agent, a dissolution aid, a viscosity adjusting agent, an ultraviolet absorbing agent, an antioxidant, and a corrosion inhibitor as necessary. In addition, regarding the treatment liquid composition, the treatment liquid composition itself is not intended for coloring, unlike the ink. Therefore, the color material is substantially not contained. The content of the color material may be 0.5% by mass or less, may be 0.1% by mass or less, or may be 0.0% by mass with respect to the total amount of the treatment liquid composition.

### 1.8. Preparation Method for Treatment Liquid Composition

Regarding a preparation method for the treatment liquid composition, the treatment liquid composition can be prepared, for example, by mixing each of the components in any order and performing filtration or the like as necessary to remove impurities, foreign substances, and the like. As a mixing method for each of the components, a method of sequentially introducing each component into a container equipped with a stirring device such as a mechanical stirrer or a magnetic stirrer, and carrying out stirring and mixing, is used. Examples of the filtration method include centrifugal filtration and filter filtration. In addition, a method used in Examples described later may be used.

### 2. Ink Set

An ink set according to the present embodiment (hereinafter, also referred to as the present ink set) includes the treatment liquid composition for ink jet described above, and an aqueous pigment ink composition containing an anionic dispersing pigment and an anionic resin particle. In a case where an ink set having such a configuration is used, the stimulus mitigating properties and the friction fastness of the textile printed matter are improved.

Hereinafter, each composition that can be contained in the ink set will be described in detail.

### 2.1. Aqueous Pigment Ink Composition

The aqueous pigment ink composition of the present ink set contains an anionic dispersing pigment and an anionic resin particle. Although not particularly limited, for example, the aqueous pigment ink composition may be adhered to a recording medium to which the treatment liquid composition is adhered, the aqueous pigment ink composition and the treatment liquid composition may be adhered to a recording medium at the same time, or the aqueous pigment ink composition may be adhered to a recording medium and then the treatment liquid composition may be adhered thereto. Among these, it is preferable to adhere the aqueous pigment ink composition and the treatment liquid composition to a recording medium at the same time.

### 2.1.1. Anionic Dispersing Pigment

The aqueous pigment ink composition of the present ink set includes an anionic dispersing pigment. The anionic dispersing pigment disperses by neutralizing the acidic group with a base, and the acidic group of the dispersing pigment, which is a weaker acid, is released by an acid in the treatment liquid composition, and thus the solubility is lowered, whereby the friction fastness is further improved.

In the aqueous pigment ink, the dispersing pigment is preferably a self-dispersing pigment. In a case where the self-dispersing pigment is contained, a neutralization reaction with the organic acid in the treatment liquid proceeds easily, and the friction fastness and the stimulus mitigating properties tend to be excellent.

Examples of the carbon black include Colour Index Generic Name (C.I.) Pigment Black 1, 7, and 11. Commercially available products of carbon black may be used, and examples thereof include No. 2300, No. 900, MCF88, No. 33, No. 40, No. 45, No. 52, MA7, MA8, MA100, No. 2200B, and the like from Mitsubishi Chemical Corporation, Raven (registered trademark) 5750, 5250, 5000, 3500, 1255, 700, and the like from Columbia Carbon Inc., Regal (registered trademark) 400R, 330R, and 660R, Mogul (registered trademark) L, Monarch (registered trademark) 700, 800, 880, 900, 1000, 1100, 1300, 1400, and the like from Cabot Corporation, and Color Black FW1, FW2, FW2V, FW18, FW200, S150, S160, and S170, Printex (registered trademark) 35, U, V, and 140U, and Special Black 6, 5, 4A, 4, and the like from Evonik Corporation. In addition, a pigment obtained by the preparation method described in Examples described later may be used.

The content of the pigment in the aqueous pigment ink is preferably 1% to 10% by mass, 2% to 8% by mass, or 3% to 7% by mass with respect to the total amount of the aqueous pigment ink composition. In a case where the content of the pigment is set within the above-described range, it is possible to more effectively and reliably exhibit the effect of the present disclosure. It is noted that the content of the pigment in the aqueous pigment ink is based on % by mass of the pigment solid content.

### 2.1.2. Anionic Resin Particle

Examples of the anionic resin particle include a resin particle, where a resin constituting the resin particle has an anionic group. Examples of the anionic group include a sulfonic acid group, a carboxyl group, a phosphoric acid group, and a hydroxyl group, where an acidic group is preferable. In a case where resin particles having an acidic group is used, the effect of the present disclosure tends to be exhibited more effectively and reliably. It is noted that the resin particle is a particle containing a resin, and although any resin particle that is in an emulsion state and in a solution state can be used, it is preferable to use a resin particle in an emulsion state from the viewpoint of suppressing an increase in the viscosity of the ink.

More specific examples of the anionic resin particles include those made from a urethane resin, a polycarbonate resin, a (meth)acrylic resin, a styrene resin, a silicone resin, a styrene acrylic resin, a fluorene resin, a polyolefin resin, a rosin-modified resin, a terpene resin, a polyester resin, a polyamide resin, an epoxy resin, a vinyl chloride resin, a vinyl chloride-vinyl acetate copolymer, and an ethylene vinyl acetate resin. Among these, a styrene acrylic resin or a urethane resin is preferable, and a urethane resin is more preferable from the viewpoint of more effectively and reliably exhibiting the effect of the present disclosure.

The content of the anionic resin particles in the aqueous pigment ink is preferably 1% to 10% by mass, 2% to 8% by mass, or 3% to 7% by mass with respect to the total amount of the aqueous pigment ink composition. In a case where the content of the anionic resin particle is set within the above-described range, it is possible to more effectively and reliably exhibit the effect of the present disclosure. It is noted that the above-described content is based on % by mass of the solid content of the anionic resin particles.

### 2.1.3. Organic Solvent

The aqueous pigment ink may contain an organic solvent. The organic solvent is not particularly limited as long as it is water-soluble, and the same kind as that used in the treatment liquid may be used. Polyhydric alcohols are preferable.

The aqueous pigment ink preferably contains glycerin or 1,2-hexanediol as an organic solvent of polyhydric alcohols. In a case where these compounds are contained, it is possible to more effectively and reliably exhibit the effect of the present disclosure.

The content of the organic solvent in the aqueous pigment ink is preferably 5% to 30% by mass, 10% to 25% by mass, or 15% to 20% by mass with respect to the total amount of the aqueous pigment ink composition. In a case where the content of the organic solvent is set within the above-described range, the stimulus mitigating properties and the friction fastness tend to be more excellent. From the same viewpoint, it is preferable that the content of the polyhydric alcohols is preferably 5% to 30% by mass or 10% to 25% by mass with respect to the total amount of the aqueous pigment ink composition.

### 2.1.4. Surfactant

The aqueous pigment ink composition may contain a surfactant. Examples of the surfactant include an acetylene glycol-based surfactant, a fluorine-based surfactant, and a silicone-based surfactant, and an acetylene glycol-based surfactant is preferably used. In a case where the acetylene glycol-based surfactant is used, it is possible to more effectively and reliably exhibit the effect of the present disclosure.

As a commercially available product of the acetylene glycol-based surfactant, SURFYNOL 465 (product name, manufactured by Nissin Chemical Co., Ltd.) is preferably used from the viewpoint that the effects of the stimulus mitigating properties and the friction fastness according to the present disclosure are further exhibited effectively and reliably.

The content of the surfactant in the aqueous pigment ink is preferably 0.1% to 5% by mass, 0.2% to 3% by mass, or 0.3% to 1% by mass with respect to the total amount of the aqueous pigment ink composition. In a case where the content of the surfactant is set within the above-described range, it is possible to more effectively and reliably exhibit the effect of the present disclosure.

### 2.1.5. pH Adjusting Agent

The aqueous pigment ink composition may contain a pH adjusting agent. The pH adjusting agent is not particularly limited; however, examples thereof include an appropriate combination of an acid, a base, a weak acid, and a weak base. Examples of such an acid and such a base include, as inorganic acids, sulfuric acid, hydrochloric acid, nitric acid, and the like; and, as inorganic bases, lithium hydroxide, sodium hydroxide, potassium hydroxide, potassium dihydrogen phosphate, sodium dihydrogen phosphate, potassium carbonate, sodium carbonate, sodium hydrogen carbonate, and ammonia. In addition, examples of the organic base include triethanol amine (TEA), diethanol amine, monoethanol amine, tripropanol amine, triisopropanol amine, diisopropanol amine, and tris(hydroxymethyl)aminomethane (THAM), and organic acids such as adipic acid, citric acid, succinic acid, lactic acid, Good's buffers such as N, N-bis(2-hydroxyethyl)-2-aminoethanesulfonic acid (BES), 4-(2-hydroxyethyl)-1-piperazineethanesulfonic acid (HEPES), morpholinoethanesulfonic acid (MES), carbamoylmethyl iminobisacetic acid (ADA), piperazine-1,4-bis(2-ethanesulfonic acid) (PIPES), N-(2-acetamide)-2-aminoethanesulfonic acid (ACES), cholamine chloride, N-tris(hydroxymethyl)methyl-2-aminoethanesulfonic acid (TES), acetamide glycine, tricine, glycine amide, and bicine, a phosphate buffer solution, a citrate buffer solution, a Tris buffer solution, or the like may be used. Among these, triethanol amine is preferable from the viewpoint of more effectively and reliably exhibiting the effect of the present disclosure.

The content of the pH adjusting agent in the aqueous pigment ink is preferably 0.1% to 5% by mass, 0.2% to 3% by mass, or 0.3% to 1% by mass with respect to the total amount of the aqueous pigment ink composition. In a case where the content of the pH adjusting agent is set within the above-described range, it is possible to more effectively and reliably exhibit the effect of the present disclosure.

As components of the aqueous pigment ink other than those described above, the aqueous pigment ink may contain, for example, various additives such as a metal sealing agent, a softening agent, a dissolution aid, a viscosity adjusting agent, an ultraviolet absorbing agent, an antioxidant, and a corrosion inhibitor as necessary.

### 2.2. Coating Liquid Composition

It is preferable that the present ink set includes an aqueous coating liquid composition, where the aqueous coating liquid composition contains an anionic resin particle and contains substantially no pigment. In a case where such a coating liquid composition is included, the friction fastness of the textile printed matter tends to be further improved. Although not particularly limited, for example, the coating liquid composition may be adhered to a recording medium to which the ink composition is adhered.

### 2.2.1. Anionic Resin Particle

The anionic resin particle contained in the coating liquid composition is not particularly limited as long as it can be used in the aqueous pigment ink composition. The anionic resin particles may form a coat layer for the ink composition that is adhered to the recording medium by reacting with the acid compound of the treatment liquid composition and aggregating.

The content of the anionic resin particles in the coating liquid composition is preferably 3% to 30% by mass, 5% to 20% by mass, or 7% to 15% by mass with respect to the total amount of the coating liquid composition. In a case where the content of the anionic resin particle is set within the above-described range, it is possible to more effectively and reliably exhibit the effect of the present disclosure.

### 2.2.2. Crosslinking Agent

The coating liquid composition may contain a crosslinking agent, and preferably contains an anionic crosslinking agent. In a case where an anionic crosslinking agent is contained, the aggregation reaction proceeds easily, and the friction fastness tends to be further excellent. One kind of crosslinking agent may be used alone, or two or more kinds thereof may be used in combination.

Among the anionic crosslinking agents, examples of the crosslinking agent include an oxazoline-based crosslinking agent, an isocyanate-based crosslinking agent, a carbodiimide-based crosslinking agent, and an epoxy-based crosslinking agent; however, an oxazoline-based crosslinker is preferable from the viewpoint of more effectively and reliably exhibiting the effect of the present disclosure.

The oxazoline-based crosslinking agent is not particularly limited; however, examples thereof include a polymer obtained by homopolymerizing an oxazoline group-containing ethylenically unsaturated monomer such as 2-isopropenyl-2-oxazoline, 2-vinyl-2-oxazoline, or the like, or copolymerizing the oxazoline group-containing ethylenically unsaturated monomer with another unsaturated monomer. In addition, examples of the commercially available product of the oxazoline-based crosslinking agent include EPOCROS (registered trademark) K-2010, K-2020, K-2030, K-2035E, WS-300, WS-500, and WS-700 (hereinabove, all product names, Nippon Shokubai Co., Ltd.). Among these, EPOCROS WS-700 is preferable from the viewpoint of more effectively and reliably exhibiting the effect of the present disclosure.

The content of the crosslinking agent is preferably 1.0% to 8.0% by mass, 1.5% to 6.0% by mass, or 2.0% to 4.0% by mass with respect to the total amount of the coating liquid. In a case where the content of the crosslinking agent is set within such a range, it is possible to more effectively and reliably exhibit the effect of the present disclosure.

As components such as a surfactant, a pH adjusting agent, and an organic solvent other than those described above, which can be contained in the coating liquid, the same kinds as those used in the above-described aqueous pigment ink composition can be used within the same content ranges. In addition, as other components, the coating liquid for example, may contain, for example, various additives such as a metal sealing agent, a softening agent, a dissolution aid, a viscosity adjusting agent, an ultraviolet absorbing agent, an antioxidant, and a corrosion inhibitor as necessary.

The treatment liquid composition and the ink set for ink jet according to the present embodiment are adhered to a fabric, whereby recording is carried out. Examples of the material of the fabric include natural fibers such as cotton, linen, wool, and silk, synthetic fibers such as polypropylene, polyesters, acetate, triacetate, polyamide, and polyurethane, and biodegradable fibers such as polylactic acid, and blended fibers thereof may be used.

The fabric preferably has a hydroxyl group. Examples of such a fabric include a fabric including cellulose such as cotton and linen, and a fabric including polyurethane. In a case where the fabric has a hydroxyl group, a crosslinking reaction may occur between the acidic component contained in the treatment liquid composition and the hydroxyl group of the fabric, and it tends to be possible to obtain an effect of improving color developing properties due to thickening and aggregation or an effect of improving friction fastness due to improved adhesion between the fabric and the recording layer.

### Examples

Hereinafter, the present disclosure will be described in more detail with reference to examples and comparative examples. The present disclosure is not limited by following Examples.

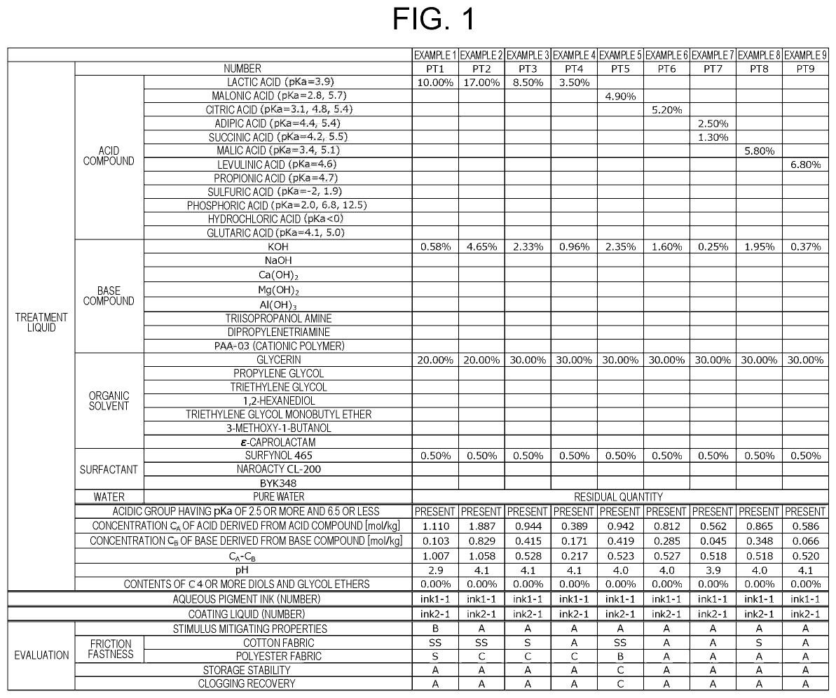

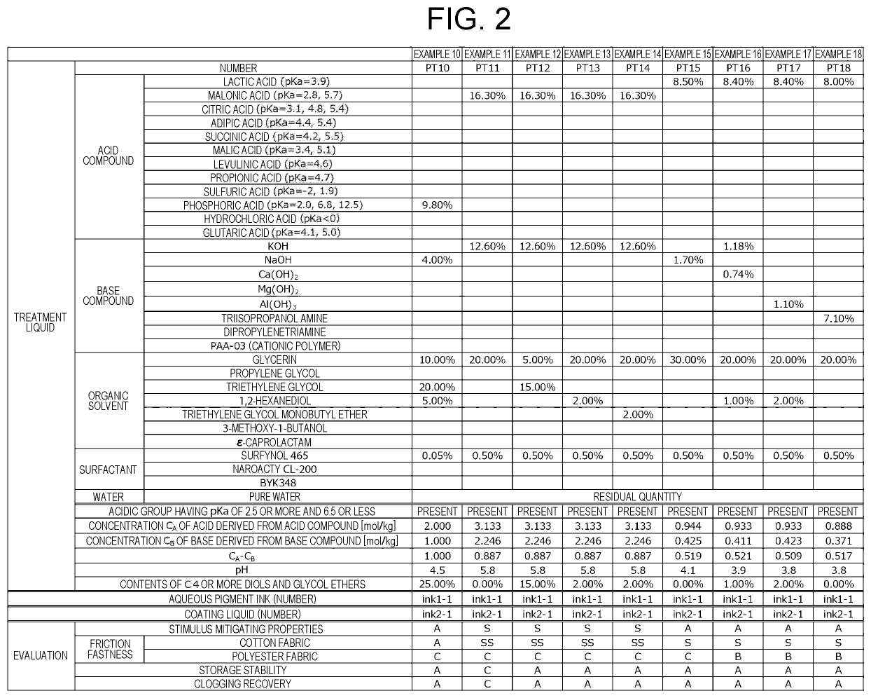

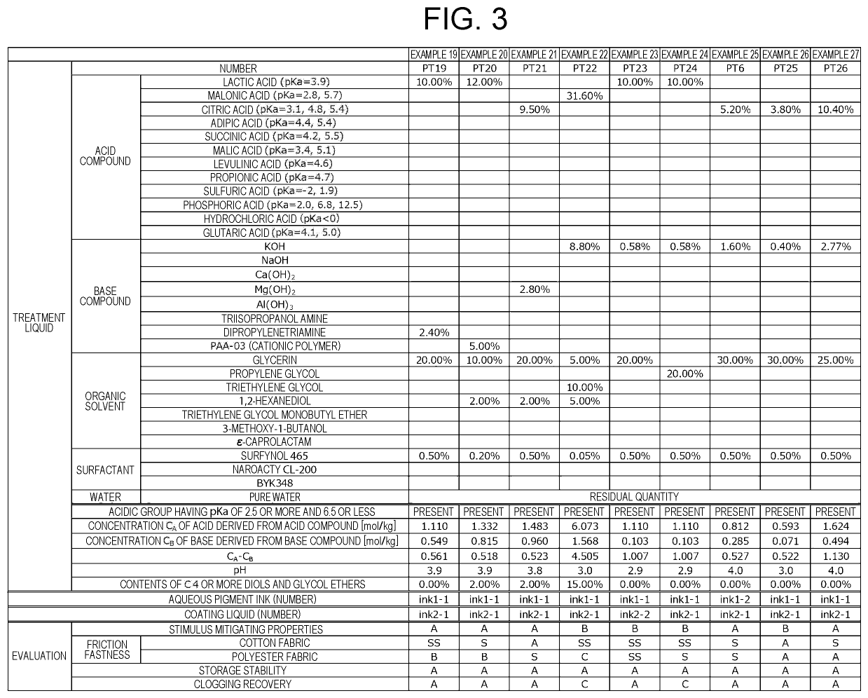

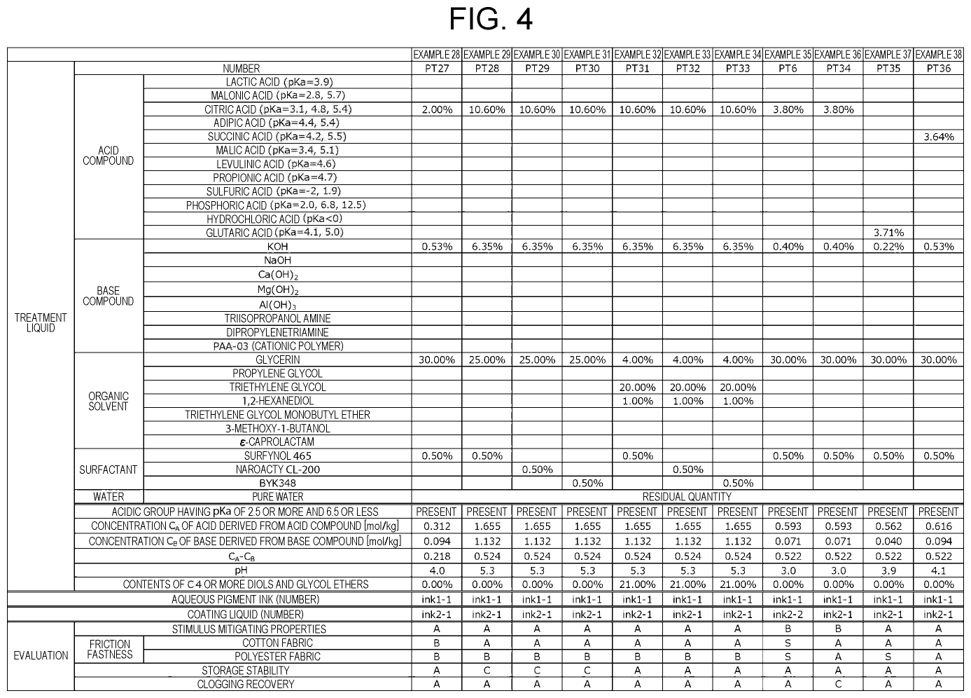

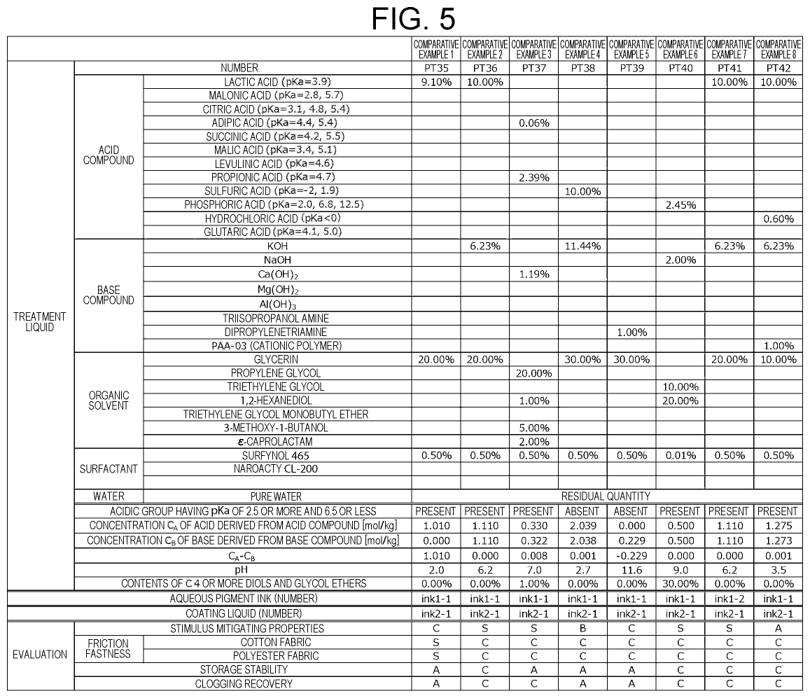

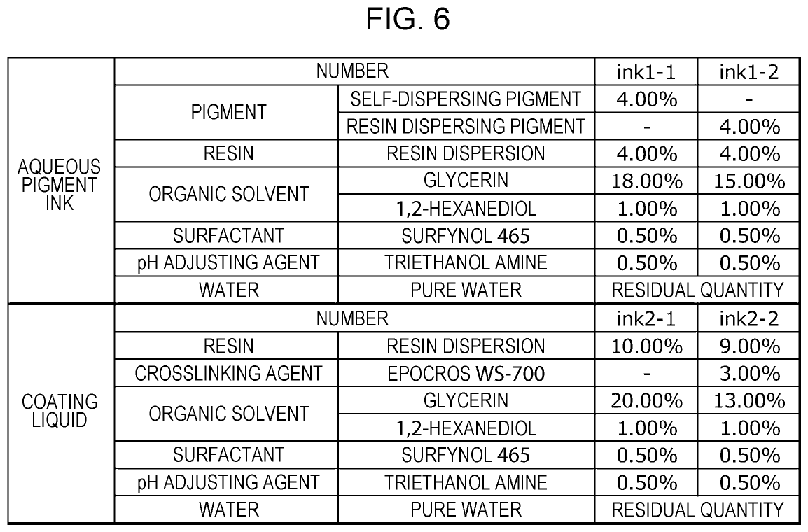

Table 1 to Table 6 showing the configuration of the composition of each of examples and comparative examples are described in FIG. 1 to FIG. 6.

### 1. Preparation of Each Composition

The respective components were put into a tank for a mixture so that the composition described in Table 1 to Table 6 was obtained. Then, they were mixed and stirred, and then filtered through a membrane filter to obtain a treatment liquid composition and an ink composition for ink jet of each example. It is noted that the numerical values of the respective components shown in the examples in the table represent % by mass unless otherwise specified. In addition, in the table, the numerical value of each content is indicated in terms of % by mass of the solid content of the active component.

The details of the abbreviations and product components used for each composition are as follows.

### 1.1. Preparation of Treatment Liquid Composition Acid Compound

Lactic acid (pka=3.9, carboxyl group, monovalent, boiling point: 122° C.)
Malonic acid (pka=2.8 and 5.7, carboxyl group, divalent, decomposition point: 135° C.)
Citric acid (pka=3.1, 4.8, and 5.4, carboxyl group, trivalent, decomposition point: 175° C.). Adipic acid (pka=4.4 and 5.4, carboxyl group, divalent, boiling point: 338° C.)
Succinic acid (pka=4.2 and 5.5, carboxyl group, divalent, boiling point: 235° C.).
Malic acid (pka=3.4 and 5.1, carboxyl group, divalent, decomposition point: 150° C.)
Levulinic acid (pka=4.6, carboxyl group, monovalent, boiling point: 246° C.)
Propionic acid (pka=4.7, carboxyl group, monovalent, boiling point: 141° C.)
Sulfuric acid (pka=−2.0 and 1.9, sulfonate, divalent, boiling point: 290° C.)
Phosphoric acid (pka=2.0, 6.8, and 12.5, phosphoric acid group, divalent, decomposition point: 213° C.)
Hydrochloric acid (pka<0, monovalent)
Glutaric acid (pKa=4.1 and 5.0, carboxyl group, divalent, boiling point: 200° C.)

### Base Compound

KOH (monovalent).
NaOH (monovalent)
Ca(OH)₂ (divalent)
Mg(OH)₂ (divalent)
Al(OH)₃ (trivalent)
Triisopropanol amine (amino group, monovalent)
Dipropylenetriamine (amino group, trivalent)
PAA-03 (cationic polymer) (polyallyl amine, amino group, pH=11, manufactured by Nittobo Medical Co., Ltd.)

### Organic Solvent

Glycerin (boiling point: 290° C.)
Propylene glycol (boiling point: 188° C.)
Triethylene glycol (boiling point: 285° C.)
1,2-hexanediol (boiling point: 223° C.)
Triethylene glycol monobutyl ether (boiling point: 278° C.)
3-methoxy-1-butanol (boiling point: 158° C.)
ε-caprolactam (boiling point: 270° C.)

### Surfactant

SURFYNOL 465 (acetylene glycol, manufactured by Nissin Chemical Co., Ltd.)
NAROACTY CL-200 (polyoxyethylene alkyl ether, manufactured by Sanyo Chemical Industries, Ltd.)
BYK 348 (polyether modified siloxane, manufactured by BYK JAPAN KK)

### Water

Pure water

### 1.2. Preparation of Aqueous Pigment Ink

### Pigment

Self-dispersing pigment: A self-dispersing pigment prepared by the following method was used.

500 g of carbon black bulk powder prepared by a furnace method (primary particle diameter=18 nm, BET specific surface area=180 m²/g, DBP absorption amount=186 mL/100 g) was added to 3750 g of ion exchange water, and the temperature was raised to 45° C. while carrying out stirring with a dissolver. After that, 30,000 g of an aqueous solution of sodium hypochlorite (effective chlorine concentration=12%) was added dropwise over 3.5 hours at 45° C. while pulverizing with a sand mill using zirconia beads having a diameter of 0.8 mm. Subsequently, the pulverization with the sand mill was continued for a further 30 minutes to obtain a treatment liquid containing a self-dispersing type carbon black. The treatment liquid was filtered through a 400-mesh wire net to separate the zirconia beads and the unreacted carbon black from the treatment liquid. A 5% potassium hydroxide aqueous solution was added to the treatment liquid obtained through the separation to adjust the pH to 7.5. Desalination and purification were then carried out using an ultrafiltration membrane until the electrical conductivity of the liquid reached 1.5 mS/cm. Desalination and purification were then further carried out using an electrodialyzer until the electrical conductivity of the liquid reached 1.0 mS/cm. The liquid was then concentrated until the self-dispersing type carbon black concentration reached 17% by mass. The concentrate was subjected to centrifugal separation with a centrifugal separator to remove coarse particles, followed by filtration through a 0.6 μm filter. Ion exchange water was added to the filtrate obtained to dilute the filtrate until the self-dispersing type carbon black concentration reached 15% by mass, and dispersion was carried out to obtain self-dispersing pigment dispersion liquid.

Resin dispersing pigment: A resin dispersing pigment prepared by the following method was used. To 15 parts by mass of carbon black, 10 parts by mass of ammonium salt (weight average molecular weight: 10,000) of a styrene-acrylic acid copolymer as a dispersing agent was added as a polymer component, and 55 parts by mass of ion exchange water was added thereto, followed by sufficient mixing. Then, the mixture was dispersed for 2 hours together with glass beads (diameter: 1.7 mm, 1.5 times the amount of the mixture) in a sand mill (manufactured by Yasukawa Seisakusho Co., Ltd.). After dispersion, the glass beads were removed to obtain a resin dispersing pigment dispersion liquid.

### Resin

Resin dispersion: A resin dispersing pigment prepared by the following method was used.

322.2 g of polytetramethylene ether glycol having a number average molecular weight of 1,000, 19.7 g of 2,2-dimethylolbutanoic acid, 16.9 g of 1,4-butanediol, 137.9 g of hexamethylene diisocyanate, and 344.0 g of methyl ethyl ketone were charged into a four-neck flask equipped with a stirrer, a cooling tube, a nitrogen introduction tube, and a thermometer, and the reaction was carried out at 80° C. in a nitrogen gas atmosphere for 6 hours. After that, cooling was carried out to 60° C., 12.5 g of triethyl amine was added thereto, and mixing was carried out for 30 minutes at this temperature. The obtained prepolymer was mixed with 1, 146.7 g of deionized water, the resultant mixture was stirred for 2 hours, and then methyl ethyl ketone was subjected to solvent removal under reduced pressure at 40° C. to obtain a polyurethane resin dispersion having a carboxyl group as an acidic group.
Organic Solvent
Glycerin
1,2-hexanediol

### Surfactant

SURFYNOL 465 (product name, acetylene glycol-based surfactant, manufactured by Nissin Chemical Co., Ltd.)

### pH Adjusting Agent

Triethanol amine

### Water

Pure water

### 1.3. Preparation of Coating Liquid

Resin
Resin dispersion: The resin dispersion used in the preparation of the aqueous pigment ink was used.

### Crosslinking Agent

EPOCROS WS-700 (product name, oxazoline-based crosslinking agent, manufactured by Nippon Shokubai Co., Ltd.)

### Organic Solvent

Glycerin
1,2-hexanediol

### Surfactant

SURFYNOL 465 (product name, acetylene glycol-based surfactant, manufactured by Nissin Chemical Co., Ltd.)

### pH Adjusting Agent

Triethanol amine

### Water

Pure water

### 2. Calculation Method

2. 1. Calculation Method for Mass Molar Concentration C_{A} of Acidic Group And Mass Molar Concentration C_{B} of Basic Group of Compound

The mass molar concentration C_{A} of the acidic group of the acid compound was calculated according to the following numerical expression.

$${C}_{A} = ( adding amount of acid compound [ \% by mass ] ) \times ( number of acidic groups having a pKa of 7 or less in one \\ molecule of acid ) \times 10 / ( molecular weight of acid compound [ g / mol ] )$$

The mass molar concentration C_{B} of the basic group of the base compound was calculated according to the following numerical expression.

$${C}_{B} = ( adding amount of base compound [ \% by mass ] ) \times ( number of hydroxyl groups or amino groups in one molecule of base ) \times 10 / ( molecular weight of base compound [ g / mol ] )$$

It is noted that in the case of an amphoteric compound such as an amino acid, the concentration was calculated in the same manner as described above according to the properties of the group having a larger number based on the difference in the number of acidic groups and basic groups. For example, in a case of L-aspartic acid as the acidic amino acid, the concentration can be calculated as follows. Aspartic acid has two carboxyl groups (pka=2.0 and 3.9) as acidic groups and one amino group as a basic group in one molecule, and an aqueous solution of aspartic acid has a pH of around 3. In a case of aspartic acid as an acid compound, the mass molar concentration C_{A} of the acidic group can be calculated according to the following numerical expression.

$$Ca = ( adding amount of acid compound [ \% by mass ] ) \times \{ ( number of acidic groups having pKa of 7 or less in one molecule of \\ acid ) - ( number of basic groups in one molecule of acid compound ) - ( number of basic groups in one molecule of acid compound ) \} \times 10 / ( molecular weight of acid compound [ g / mol ] )$$

It is as follows in a case where the adding amount of aspartic acid is 10% by mass.

$$Ca = 10 \times ( 2 - 1 ) \times 10 / 133.1 \approx 0.751$$

It is noted that the molecular weight and valence of the compound of which the molecular weight and the number of acidic groups (or basic groups) were unknown were calculated according to the following methods.

### 2. 2. Calculation Method for Molecular Weight And Valence of Compound of Which Molecular Weight And Number of Acidic Groups (or Basic Groups) Are Unknown

0.30 g of a compound of which the molecular weight and the number of acidic groups (or basic groups) are unknown is dissolved in 29.70 g of pure water to prepare an aqueous solution of 30.00 g. The procedure of adding dropwise 0.03 g of a 10 wt % sodium hydroxide (or sulfuric acid) to the aqueous solution of the compound, stirring the resultant mixture with a magnetic stirrer, and then measuring the pH of the aqueous solution using a pH meter (F-72, manufactured by HORIBA, Ltd.) was repeated, and it was determined that the neutralization was achieved in a case where the pH of the aqueous solution reached 8.0 (or 6.0), and the repeated operation was ended. From this result, the adding amount ax (or bx) (g) of the acid compound (or base compound) required to neutralize 1 g of sodium hydroxide (or 1 g of sulfuric acid) of 100 wt % was calculated using the following numerical expression.

$${a}_{x} = 0.3 g / ( adding amount ( g ) of 100 wt \% sodium hydroxide )$$

$${b}_{x} = 0.3 g / ( adding amount ( g ) of 100 wt \% sulfuric acid )$$

Here, (adding amount (g) of 100 wt % sulfuric acid=(adding amount (g) of 10 wt % sulfuric acid)/10, and (adding amount (g) of 100 wt % sulfuric acid=(adding amount (g) of 10 wt % sulfuric acid)/10. Next, an aqueous solution of 1 wt % sulfuric acid (or 1 wt % sodium hydroxide aqueous solution) was subjected to the above-described operation to calculate the adding amount a_{H2SO4} (g) (or b_{KOH} (g)) of sulfuric acid (or potassium hydroxide) required to neutralize 1 g of 100 wt % sodium hydroxide (or 100 wt % sulfuric acid), and the molecular weight (g/mol) per acidic group (or basic group) was calculated using the following numerical expression.

$$98.08 \times {a}_{x} / {a}_{H 2 SO 4}$$

$$40. \times {b}_{x} / {b}_{KOH}$$

### 3. Printing Method

Using a device obtained by modifying ML-8000 (manufactured by Seiko Epson Corporation), a white broad fabric of 100% cotton (#4000, manufactured by Nisshinbo Holdings Inc.) or a polyester fabric was subjected to printing by ejecting a treatment liquid composition and an aqueous pigment ink were from a head within the same path, the same scanning region was subjected to main scanning a plurality of times (2 times, 4 times, 8 times, 12 times, or 16 times), and then a coating liquid was subsequently subjected to printing in the same manner, thereby forming a solid pattern image of 20 cm×5 cm on the fabric, which is a recording medium. It is noted that the adhesion amount of each liquid was set to 10 mg/inch² for the treatment liquid composition, 30 mg/inch² for the aqueous pigment ink, and 20 mg/inch² for the coating liquid. After image formation, a heating treatment and drying were carried out at 160° C. for 5 minutes in an oven to prepare a textile printed matter of each example and each comparative example. It is noted that the “solid pattern image” means an image in which dots were uniformly formed on the entire surface of the recording region (main scanning direction×sub-scanning direction: 20 cm×5 cm) so that the coating amount of each liquid reached the numerical value described above. It is noted that for the ink jet head, a head unit, in which a nozzle distance was 600 dpi in the sub-scanning direction and two head chips were disposed in the sub-scanning direction to have a nozzle length of 2 inches, was used.

### 4. Evaluation Method

### 4.1. Stimulus Mitigating Properties

From the textile printed matter created on the cotton fabric by using the above-described printing method, a printed image was cut to have an area of 15 cm×3.2 cm and cut into small pieces having a width of 5 mm, which were subsequently put into a glass bottle together with 35 mL of pure water. Next, extraction was carried out by stirring for 2 hours using a magnetic stirrer. After that, the pH of the extraction liquid was measured using a pH meter (F-72, manufactured by HORIBA). This operation was repeated three times, and the evaluation was carried out according to the following standards based on the average value of the measured values of pH.

### Evaluation Standards

S: The average value of pH is 4.7 or more.

A: The average value of pH is 4.4 or more and less than 4.7.

B: The average value of pH is 4.2 or more and less than 4.4.

C: The average value of pH is less than 4.2.

### 4.2. Friction Fastness (of Cotton Fabric or Polyester Fabric)

A textile printed matter was created on each of the cotton fabric and the polyester fabric using the above-described printing method. On the other hand, the textile printed matter was rubbed 10 times with a load of 9 N on the image of the textile printed matter with unbleached muslin (cotton white cloth) using a clock meter (FI-306, manufactured by Tester Sangyo Co., Ltd.). Thereafter, for the region contaminated with the ink of the rubbed unbleached muslin, the optical density (OD, Status E) of black of the printed image was measured using a colorimeter (FD-7, manufactured by Konica Minolta, Inc.) and evaluated according to the following standards.

### Evaluation Standards

SS: OD is 0.22 or less.

S: OD is 0.22 or more and 0.31 or less.

A: OD is more than 0.31 and is 0.4 or less.

B: OD is more than 0.4 and is 0.5 or less.

C: OD is more than 0.5.

### 4.3. Storage Stability of Treatment Liquid

Each of the treatment liquid compositions obtained as above was allowed to stand for 3 days in an environment at a temperature of 60° C. Next, the treatment liquid composition was further allowed to stand at room temperature for 1 day, and then the presence or absence of phase separation was checked. Further, the composition was stirred, and the change in transparency was visually evaluated according to the following standards.

### Evaluation Standards

A: The separation of the oil layer and the water layer was not observed, and no turbidity was observed even after stirring.

C: The separation of the oil layer and the water layer was not observed, or the transparency was decreased and the color was turbid after stirring.

### 4. 4. Clogging Recovery of Treatment Liquid

An ink cartridge of an ink jet printer PX-G930 (product name, manufactured by Seiko Epson Corporation) was filled with each of the treatment liquid compositions obtained as above, and continuous ejection was carried out from all nozzles for 3 minutes. After the ejection, it was allowed to stand for two weeks at a temperature of 40° C. and a relative humidity of 20%. After that, as the cleaning of the head, the operation of suction of the treatment liquid in the nozzle was carried out once, the presence or absence of the nozzle in which the treatment liquid could not be ejected was checked. Then, the cleaning operation was carried out again to check whether or not all the nozzles were recovered. Based on the results therefrom, the evaluation was carried out according to the following standards.

### Evaluation Standards

A: Clogging did not occur, or recovery was observed by one time of cleaning.

C: Clogging occurred, and recovery was observed or recovery was not observed by two times of cleaning.

It is noted that although the eject reliability of the aqueous pigment ink was favorable in all cases, the ink of Example 25 using an ink 1-2 (resin dispersing pigment) was slightly inferior in eject reliability (susceptible to clogging) as compared with the ink of Example 6 using an ink 1-1 (self-dispersing pigment).

### 5. Evaluation Results

From Table 1 to Table 6, it can be seen that a textile printed matter to be obtained has excellent stimulus mitigating properties and excellent friction fastness in a case where a treatment liquid composition for ink jet is used, where the treatment liquid composition for ink jet is used by being adhered to a recording medium, the treatment liquid composition for ink jet, containing an acid compound, a base compound, water, in which in the acid compound, a pKa at 25° C. in water is at least 2.5 or more and 7.0 or less, and in the treatment liquid composition for ink jet, a difference (C_{A}−C_{B}) between a mass molar concentration C_{A} (mol/kg) of an acidic group derived from the acid compound and a mass molar concentration C_{B} (mol/kg) of a basic group derived from the base compound is 0.01 or more, and a pH at 25° C. is 2.5 or more and 6.5 or less.

What is claimed is:

1. A treatment liquid composition for ink jet, which is used by being adhered to a recording medium, the treatment liquid composition for ink jet, comprising:
an acid compound;
a base compound; and
water, wherein
in the acid compound, a pka at 25° C. in water is at least 2.5 or more and 7.0 or less, and
in the treatment liquid composition for ink jet, a difference (C_{A}−C_{B}) between a mass molar concentration C_{A} (mol/kg) of an acidic group derived from the acid compound and a mass molar concentration C_{B} (mol/kg) of a basic group derived from the base compound is 0.01 or more, and
a pH at 25° C. is 2.5 or more and 6.5 or less.

2. The treatment liquid composition for ink jet according to claim 1, wherein
a difference (C_{A}−C_{B}) between the mass molar concentration C_{A} (mol/kg) and the mass molar concentration C_{B} (mol/kg) is 5.0 or less.

3. The treatment liquid composition for ink jet according to claim 1, wherein
the base compound includes a hydroxide of one or more metals selected from the group consisting of Li, Na, K, Ca, Mg, and Al, or an amine compound.

4. The treatment liquid composition for ink jet according to claim 1, wherein
the base compound includes a hydroxide of one or more metals selected from the group consisting of Ca, Mg, and Al, or an amine compound having 2 to 10 nitrogen atoms in a molecule.

5. The treatment liquid composition for ink jet according to claim 1, wherein
the treatment liquid composition for ink jet contains two or more kinds of the base compounds.

6. The treatment liquid composition for ink jet according to claim 1, wherein
in the acid compound, a standard boiling point or a thermal decomposition point at atmospheric pressure is 170° C. or lower.

7. The treatment liquid composition for ink jet according to claim 1, wherein
the acid compound includes one or more selected from the group consisting of lactic acid, levulinic acid, malic acid, malonic acid, citric acid, phosphoric acid, succinic acid, glutaric acid, and adipic acid.

8. The treatment liquid composition for ink jet according to claim 1, wherein
in the acid compound, a pka at 25° C. in water is at least 4.5 or more and 6.5 or less.

9. The treatment liquid composition for ink jet according to claim 1, wherein
the acidic group includes one or more selected from the group consisting of a carboxyl group, a sulfo group, and a phosphoric acid group, and
the basic group includes one or more of a hydroxyl group and an amino group.

10. The treatment liquid composition for ink jet according to claim 1, wherein
the treatment liquid composition for ink jet contains a nonionic surfactant and a water-soluble organic solvent, and
the water-soluble organic solvent includes one or more of a diol compound having 4 or more carbon atoms and glycol ethers having 4 or more carbon atoms.

11. The treatment liquid composition for ink jet according to claim 10, wherein
a content of the water-soluble organic solvent is 30% by mass or less with respect to a total amount of the treatment liquid composition for ink jet.

12. The treatment liquid composition for ink jet according to claim 1, wherein
the mass molar concentration C_{A} (mol/kg) of the acidic group is 0.3 mol/kg or more with respect to a total amount of the treatment liquid composition for ink jet.

13. The treatment liquid composition for ink jet according to claim 1, wherein
the treatment liquid composition for ink jet contains 5.0% by mass or more of a water-soluble organic solvent having a standard boiling point of 280° C. or higher with respect to a total amount of the treatment liquid composition for ink jet.

14. An ink set comprising:
the treatment liquid composition for ink jet according to claim 1; and
an aqueous pigment ink composition containing an anionic dispersing pigment and an anionic resin particle.

15. The ink set according to claim 14, wherein
the dispersing pigment is a self-dispersing pigment.

16. The ink set according to claim 14, wherein
the resin particle has an acidic group.

17. The ink set according to claim 14, further comprising:
an aqueous coating liquid composition, wherein
the aqueous coating liquid composition contains an anionic resin particle and contains substantially no pigment.

18. The ink set according to claim 17, wherein
the aqueous coating liquid composition contains an anionic crosslinking agent.
